(19) United States
(12) Patent Application Publication
(10) Pub. No.: US 2005/0221216 A1
(43) Pub. Date: Oct. 6, 2005

(54) Silver halide color photographic sensitive material and it image forming method

(76) Inventors: Kazuhiro Miyazawa, Tokyo (JP); Toyoki Nishijima, Tokyo (JP)

Correspondence Address: FRISHAUF, HOLTZ, GOODMAN & CHICK, PC, 220 5TH AVE FL 16, NEW YORK, NY, 10001-7708, US

(21) Appl. No.: 10/520,888

(22) PCT Filed: Jul. 18, 2002
(86) PCT No.: PCT/JP02/07310

§ 371 Date: Jan. 11, 2005

(51) Int. Cl. G03C 8/00

(52) U.S. Cl. 430/218

(57) ABSTRACT

A silver halide color photographic material containing a substrate, incorporating thereon a yellow color image forming layer, a magenta color image forming layer and a cyan color image forming layer, all of which incorporate photosensitive silver halide grains, wherein, when the silver halide color photographic material is exposed with a laser light at an exposure time of 10⁻¹⁰-10⁻³ seconds per pixel, and then is subjected to photographic processing to obtain a color image, a difference of VE values (ΔVE), between a maximum VE value and a minimum VE value, is between 0.0-0.2, in which VE is an effective gradation region of each color image forming layer in the obtained color image.

### TECHNICAL FIELD OF THE INVENTION

The present invention relates to a silver halide color photographic material to provide color prints by exposure and development based on a digital information, and to an image forming method using the same, it especially relates to a silver halide color photographic material exhibiting enhanced text image reproducibility, even when it is to be exposed by varying digital exposure apparatuses having different light sources and exposure methods, as well as-an image forming method using the same. Further, it relates to a silver halide color photographic material to provide prints exhibiting improved printing stability in highlighted areas, and an image forming method using the same.

### BACKGROUND OF THE INVENTION

In recent years, due to the increase of calculating capacity of computers and progress of networking techniques, the likelihood to deal with image as digital data is rapidly increasing. Image information obtained by using a digital camera, or image information converted from film or print to digital data using a scanner, is relatively easily subjected to editing and processing on a computer, or adding data such as text or other illustrations. As examples of hardcopy materials to provide a hardcopy based on these digitalized image information, listed are a sublimation thermal transfer print, a melting thermal print, an ink-jet print, an electrostatic image transfer type print, a thermo-autochrome print, and a print via a silver halide color photographic material. Of these, a silver halide color photographic material (hereinafter, referred to simply as a photographic material) exhibits excellent characteristics, such as high speed, gradation, image storage stability, and production cost, compared to other printing materials. Specifically, it is nowadays widely employed for making high quality hard copy prints.

Since image information converted to digital data is relatively easily subjected to editing and processing, there is correlated increase in opportunities to deal with images which contain both an image based on photographed data such as a person, scenery, or still life (hereinafter, referred to as “a scene image”), and text image (especially, thin and small font black text images). Therefore, in image output based on digital data, it is essential to satisfy these two types of images at the same time, which specifically are to reproduce scene images to be more realistic, and to reproduce text images to be no bleeding. As digital exposure devices exposing visual image information converted to digital data, currently many models are available in the market. Further, combining with progress of exposure light sources and digital exposure devices, many new types of digital exposure devices have been researched and developed. Of these digital exposure devices, those employing light sources of narrow beam light sources such as lasers and LEDs are becoming the mainstream.

However, the kinds of lasers and LEDs loaded on digital exposure apparatuses are not integrated, resulting in many cases having different exposure wavelength in each exposure apparatus. Further, in many cases, differences are observed on other points, such as overlapping ratio of exposure beams, exposure time intervals among adjacent pixels, and exposure time and exposure intensity per pixel, even when the same type of exposure light source is employed. Therefore, when a different exposure apparatus is used, the resulting print quality differs to result in the case generating chromatic bleeding especially at the interference fringe of text images. There is a strong desire to overcome theses problems.

Further, depending on the kinds of exposure apparatuses, maybe, due to difficulty of stable control of a light amount in a low exposure amount region, printed density in highlighted areas sometimes fluctuates, even when printing is conducted using the same digital data. There is a strong desire to minimize this problem.

It is possible to minimize these problems by optimizing the photographic material for each exposure apparatus or condition of use, however, these are not realistic solution, because the kinds of digital exposure devices in the market now are so many, and more are continually marketed. Under these circumstances, it is desired to provide a silver halide color photographic material to obtain excellent prints exhibiting a sharp text fringe with less bleeding, and reduced density fluctuation in highlighted areas, employing any kind of exposure apparatuses, or varying usage conditions, and an image forming method using the same.

Regarding the above problems, a method to improve print quality is described in Unexamined Japanese Patent Application Publication (hereinafter, referred to as JP-A) 3-158847, in which a method is disclosed to control the average point gamma and fluctuation range in a given density region. While it emphasizes reduction of exposure unevenness, it does not at all mentioned reduction of chromatic bleeding of text images. Further, a method to define the relationship of instantaneous contrast and exposure amount is disclosed in JP-A 8-36247. Further, in JP-A 9-171237, disclosed is a method to obtain a maximum gamma and fill-in Dmax density by a certain defined range of exposure to become more than the fixed value. Furthermore, in JP-A 2000-321730, to improve image quality over a wide range of exposure, disclosed is a method to suppress an in-max density lowering rate of each color image forming layer at an exposure range of 1,000 nanoseconds—0.5 seconds less than a specific value. However, neither of these methods mentions simultaneous pursuit of color bleeding reduction of a text image and density fluctuation reduction in highlighted areas regardless of the characteristics of the exposure devices.

An object of the present invention relates to a silver halide color photographic material to obtain a color print by exposure and development based on digital information, and an image forming method using the same. Specifically it is to provide a silver halide color photographic material exhibiting enhanced text image reproducibility, even when it is exposed by various digital exposure apparatuses employing different light sources and exposure methods, and to provide an image forming method using the same. Further, an object is to provide a silver halide color photographic material to obtain prints exhibiting improved printing stability in highlighted areas, and an image forming method using the same.

### SUMMARY OF THE INVENTION

It is an object to overcome disadvantages of prior photographic products.

It is another object to provide a silver halide color photographic material exhibiting enhanced text image reproducibility, even when exposed by various digital exposure devices employing different light sources and exposure methods, and to provide an image forming method using the same.

It is a further object to provide a silver halide color photographic material to obtain prints exhibiting improved printing stability in highlighted areas, and an image forming method using the same.

### DETAILED DESCRIPTION OF THE INVENTION

The above-mentioned objects of the invention are accomplished by the following embodiments.

(1) A silver halide color photographic material comprising a substrate, having thereon a yellow color image forming layer, a magenta color image forming layer and a cyan color image forming layer, all of which incorporate photosensitive silver halide grains,

wherein, when the silver halide color photographic material is exposed with a laser light at an exposure time of 10⁻¹⁰ to 10⁻³ seconds per one pixel, and then is subjected to photographic processing to obtain a color image,

the difference of VE values (ΔVE) of the color image, between a maximum VE value and a minimum VE value, is between 0.0-0.2, in which VE is an effective gradation region of each color image forming layer in the obtained color image.

(2) The silver halide color photographic material of (1) above, wherein at least one-color image forming layer comprises a four equivalent coupler.

(3) The silver halide color photographic material of (1) or (2), wherein at least one color image forming layer comprises the silver halide grains containing a metal of the 8th to 10th groups in the periodic table.

(4) The silver halide color photographic material of (3), wherein the metal of the 8th to 10th groups in the periodic table is contained in the silver halide grains as a metal complex having at least one ligand of nitrosyl or imidazole.

(5) An image forming method comprising the steps of:
a) exposing the silver halide color photographic material of any one of (1) - (4), at an exposure time of 10⁻¹⁰ to 10⁻³ seconds per pixel, and
b) conducting color photographic processing on the exposed photographic material.

### DESCRIPTION OF THE PREFERRED EMBODIMENTS

The present invention is characterized by differences of VE values (ΔVE) between the color image forming layer exhibiting the maximum VE value and the color image forming layer exhibiting the minimum VE value in the effective gradation region (VE) of the obtained color images, being in the range of 0-0.2, when the silver halide color photographic material is exposed by exposure time of from 10⁻¹⁰-10⁻³ seconds, and is subjected to photographic processing to obtain a color image.

Usually, when image information is dealt with after being digitalized, a conventional method is that the original image is divided into a fine grid and the density information of each such grid is digitalized. In this invention, the smallest unit is designated as “pixel”, when the original image is divided into a grid. In view of this, the expression of “exposure time per pixel” is considered to be the time to control light beam intensity or radiation time, based on the digital data of each pixel.

The effective gradation region (VE) of this invention is defined to be the exposure region of which the point gamma value is 1.0 or more at gray scale output. As a result of diligent investigation, the inventors of this invention found that this exposure region had a significant effect on print quality during digital exposure, and especially affected excessive bleeding of text images.

ΔVE of this invention is the difference (ΔVE) of the VE value of the color image forming layer exhibiting the maximum effective gradation region (VE) determined as above, and the VE value of the color image forming layer exhibiting the minimum gradation region. It is presumed that, in cases when the ΔVE value is relatively small, balance of yellow, magenta and cyan portions of images is relatively well maintained, resulting in reduction of excessive chromatic bleeding at text fringes.

In this invention, by satisfying the requirements defined in this invention under the exposure conditions of exposure time per pixel, being 10⁻¹⁰ or more—10⁻³ seconds or less, the desired effects of this invention are obtained. To describe the effects of this invention more clearly, the following evaluation methods are preferably employed.

That is, the point gamma is determined as follows: a) using a laser scanning exposure device which controls the overlaps of light beams to be in the range of 5-50%, b) 1 cm² patches are exposed on a photographic material, while varying exposure amount, c) color development is conducted at 37±0.5° C. for 45 seconds, using the following color developing solution (being CDC-1), followed by usual bleach-fixing processing, and washing or stabilizing processing, d) reflection density of the gray patches on the obtained sample is determined, and the characteristic curves in which the horizontal axis indicates exposure amount (Log E), and the vertical axis indicates reflection density (D), e) the derivative value of exposure amount vs density at each step is calculated to determine- the point gamma.

Color Developing Solution (CDC-1)

| | | |
|---|---|---|
| Water | 800 | ml |
| Triethylenediamine | 2 | g |
| Diethylene glycol | 10 | g |
| Potassium bromide | 0.02 | g |
| Potassium chloride | 4.5 | g |
| Potassium sulfite | 0.25 | g |
| N-ethyl-N-(β-methane sulfonamide ethyl) - | 4.0 | g |
| methyl-4-aminoaniline sulfate | | |
| N,N-diethylhydroxylamine | 5.6 | g |
| Triethanolamine | 10.0 | g |
| Diethylenetriaminepentaacetate | 2.0 | g |
| sodium salt | | |
| Potassium carbonate | 30 | g |

The total volume is brought to be one liter by addition of water, and the pH is adjusted to 10.1 by addition of sulfuric acid or potassium-hydroxide.

In this invention, it is specifically preferred to employ a four equivalent coupler in at least one of the color image forming layers, from the viewpoint of enhancing the improvable effects of print stability in highlighted areas. The reason for usage of a four equivalent coupler, which enhances print stability in highlighted areas is uncertain, however, one of the factors is presumed to be that the necessity of two quinone diimine molecules to form a colored dye inhibits formation of a colored dye by quinone diimine generated noise. Specifically, in cases when four equivalent couplers are represented by following Formula (1), the visually observed print stability effect in highlighted areas is large, which makes this a specifically preferable embodiment.

The photographic material which exhibits the effects of this invention, contains a four equivalent magenta coupler of a 5-pyrazolone coupler, and specifically contains a four equivalent, 5-piyazolone magenta coupler represented by Formula (1).

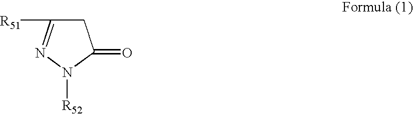

In above Formula (1), R₅₁ is a carbonamide group or an anilino group, while R₅₂ is a phenyl group which may be substituted. Of these couplers represented by Formula (1), specifically preferred is a coupler having a carboxylic acid amide group. These couplers may be polymer couplers, of which 5-pyrazolone magenta couplers, being well known in the art, may be employed. For example, listed are four equivalent magenta couplers (M-1)-(M-38) described in Examined-Japanese Patent Publication 5-8415, on pp. 12-21.

In this invention, the specifically preferable embodiment is that at least one color image forming layer contains silver halide grains containing a metal of the 8th-10th groups in the periodic table, from the viewpoint of simultaneous target of higher maximum density and print stability in highlighted areas. As metals of the 8th-10th groups in the periodic table, iron, iridium, platinum, palladium, nickel, rhodium, osmium, ruthenium, and cobalt are preferably-employed. Of these, iron, iridium, rhodium, osmium, and ruthenium are specifically preferred. These metals may be added to the -silver halide emulsion in the form of salt or a complex salt.

In cases when the foregoing metal forms a complex salt, as a ligand or ion, listed are a cyanide ion, a thiocyanide ion, an isothiocyanate ion, a cyanate ion, a chloride ion, a bromide ion, an iodide ion, a nitrate ion, a carbonyl and ammonia. Of these, preferred ions are: cyanide, thiocyanate, isothiocyanate, chloride, and bromide.

Specifically preferred is a transition metal complex containing a nitrosyl or thionitrosyl ligand and a transition metal selected from the 8th-10th groups of the periodic table. This is generally defined by the following structural formula.
Formula: [TE¹₄(NZ)E²]^{r}

In the above formula, T is a transition metal selected from the 8th-10th groups in the periodic table, Z is a oxygen atom or a sulfur atom, forming a nitrosyl ligand or a thionitrisyl ligand together with a nitrogen atom, E¹ and E² are each a ligand differing from a nitrosyl ligand or a thionitrosyl ligand, and “r” is 0 or −1 to −3. This transition metal is preferably selected from the 8th group in the periodic table. The optimum one is osmium or ruthenium.

The specific examples represented by the above E¹ include ligands of: an aquo, a halide, a cyanide, a cyanate, a thiocyanate, a selenocyanate, a tellurocyanate and an azido. Examples of compounds include Compounds TMC-1-TMC-126, described in JP-A 8-211530, paragraph Nos. 0016-0023. Further, also preferably employed is a complex including an imidazole group as a ligand. Examples of compounds include the compounds described in JP-A 2000-112052, paragraph Nos. 0054-0058.

To incorporate the foregoing metal in silver halide grains, a compound of the metal merely needs to be added at an appropriate period in each process during physical ripening, such as before, during or after formation of silver halide grains. Further, regarding the addition, an aqueous solution of the heavy metal is continuously added during the entire whole or only a portion of the grain forming process.

The amount of the foregoing heavy metal added to the silver halide emulsion is preferably 1×10⁻⁹ mol or more, and 1×10⁻² mol or less per mol of silver, but specifically preferred is 1×10⁻⁸-5×10⁻⁵ mol.

To form a photographic image using the silver halide photographic material of this invention, it is preferable to employ an appropriate exposure method of an exposure time of more than 10⁻¹⁰ seconds and less than 10⁻³ seconds per pixel based on digital image data. Among the methods, a scanning exposure method of light beams is preferably employed from the viewpoint of obtaining high quality prints, while maintaining high print productivity.

Scanning exposure with light beams, as preferably employed in this invention, is usually conducted in combination of linear exposure with light beams (being so-called raster exposure=main scanning), and the relative transition of the photographic material to the perpendicular direction to the linear exposure direction (being sub-scanning). For example, in many cases, the photographic material is secured to the outer or inner circumference of a cylindrical drum, and the main scanning is conducted by rotation of the drum under light beams radiation, and at the same time, the sub-scanning is conducted by perpendicular transition of the light source to the rotation direction of the drum (being a drum method); or, scanning horizontal to the rotation plane of a polygon mirror is conducted, by radiation of reflected beams to the rotating polygon mirror (being main scanning), and at the same time, sub-scanning is conducted by perpendicular transition of the photographic material to the rotation plane of the polygon mirror (being a polygon method). In the drum method, the main scanning rate can be-adjusted by controlling a drum diameter or drum rotating speed, and the sub-scanning rate can be adjusted by controlling transition rate of the light source. Further, in the polygon method, the main scanning rate can be adjusted by controlling size, plane numbers, and rotating rate of the polygon mirror, and the sub-scanning rate can be adjusted by controlling the transition rate of the photographic material.

Overlapping of rasters of light beams can be adequately controlled by adjusting the timing of the main scanning rate and the sub-scanning rate. Further, when using an exposure head featuring an array of light sources, overlapping of rasters of light beams can be adequately controlled by adjusting the interval of each light source.

The kinds of light sources employable in this invention include ones well known in the art, such as light-emitting diodes (LED), gas lasers, laser diodes (LD), combination of a LD or a solid laser using an LD as an excitation light source with a second harmonic conversion element (being a so-called SHG element), an organic or inorganic EL element, and a fluorescent display tube. Further, a light source combining a shutter element such as a PLZT element, a DMD element or a liquid crystal, with a light source such as a halogen lamp, and a color filter, are preferably employed.

In the silver halide photographic material of the present invention,. employed may be additives and methods other-than above-mentioned components, such as a silver halide emulsion, additive agents to the emulsion, a sensitizing method, an antifogging agent, a stabilizing agent, an anti-irradiation agent, a fluorescent brightening agent, a yellow coupler, a magenta coupler, a cyan coupler, a spectral sensitizing dye, an emulsifying method, a surface active agent, an anti-color contamination agent, a binder, a hardening agent, a slippage agent as well as a matting agent, a substrate, a blue tinting agent and a red tinting agent, a coating method, an exposure method, a color developing agent, a processing method, a processing apparatus, and processing chemicals, all of which are described in JP-A 11-347615, paragraph [0014] on line 22 on the left of pg. 9 to [0106] on line 17 on the left of pg. 14.

### EXAMPLES

Next, the present invention will be detailed with reference to examples, however, the embodiments of the present invention are not limited to these examples.

### Example 1

Preparation of Sample 101

Both sides of 180 g/m² pulp paper were laminated with high density polyethylene, to prepare a paper substrate. Further, the emulsion layer coating side was laminated with molten polyethylene containing 15 weight % of surface treated, emulsified anatase type titanium oxide, whereby a reflective substrate was prepared. After this reflective substrate was subjected to corona discharge treatment, a gelatin subbing layer was applied, and further, each of the layers, containing the following components, was coated, resulting in Sample 101 of a silver halide photographic material. Employed were H-1 and H-2 as hardening agents, and F-1 as an antiseptic agent.

Constitution of Sample 101

| | [g/m²] |
|---|---|
| The 7th Layer (a Protective Layer) | |
| Gelatin | 1.00 |
| DBP | 0.002 |
| DIDP | 0.002 |
| Silicon dioxide | 0.003 |
| The 6th Layer (a UV Absorbing Layer) | |
| Gelatin | 0.40 |
| AI-1 | 0.01 |
| UV absorbing agent (UV-1) | 0.084 |
| UV absorbing agent (UV-2) | 0.027 |
| UV absorbing agent (UV-3) | 0.114 |
| Antistaining agent (HQ-5) | 0.04 |
| PVP | 0.03 |
| The 5th Layer (a Red Sensitive Layer) | |
| Gelatin | 1.30 |
| Red sensitive silver chlorobromide | 0.21 |
| emulsion (Em-R) | |
| Cyan coupler (C-1) | 0.25 |
| Cyan coupler (C-2) | 0.08 |
| Dye image stabilizing agent (ST-1) | 0.10 |
| Antistaining agent (HQ-1) | 0.004 |
| DBP | 0.10 |
| DOP | 0.20 |
| The 4th Layer (a UV Absorbing Layer) | |
| Gelatin | 0.94 |
| UV absorbing agent (UV-1) | 0.196 |
| UV absorbing agent (UV-2) | 0.063 |
| UV absorbing agent (UV-3) | 0.266 |
| AI-1 | 0.02 |
| Antistaining agent (HQ-5) | 0.10 |
| The 3rd Layer (a Green Sensitive Layer) | |
| Gelatin | 1.30 |
| AI-2 | 0.01 |
| Green sensitive silver chlorobromide | 0.14 |
| emulsion (Em-G) | |
| Magenta coupler (M-1) | 0.20 |
| Dye image stabilizing agent (ST-3) | 0.20 |
| Dye image stabilizing agent (ST-4) | 0.17 |
| DIDP | 0.13 |
| DBP | 0.13 |
| The 2nd Layer (a Inter Mediate Layer) | |
| Gelatin | 1.20 |
| AI-3 | 0.01 |
| Antistaining agent (HQ-2) | 0.03 |
| Antistaining agent (HQ-3) | 0.03 |
| Antistaining agent (HQ-4) | 0.05 |
| Antistaining agent (HQ-5) | 0.23 |
| DIDP | 0.04 |
| DBP | 0.02 |
| Fluorescent brightening agent (W-1) | 0.10 |
| The 1st Layer (a Blue Sensitive Layer) | |
| Gelatin | 1.20 |
| Blue sensitive silver chlorobromide | 0.26 |
| emulsion (Em-B) | |
| Yellow coupler (Y-1) | 0.70 |
| Dye image stabilizing agent (ST-1) | 0.10 |
| Dye image stabilizing agent (ST-2) | 0.10 |
| Antistaining agent (HQ-1) | 0.01 |
| Dye image stabilizing agent (ST-5) | 0.10 |
| Image stabilizing agent A | 0.15 |
| DNP | 0.05 |
| DBP | 0.15 |

Substrate: polyethylene laminated paper (containing a slight amount of coloring agents)

The added amount of each of the above silver halide emulsions was indicated as being converted to silver.

The details of additives employed in above Sample 101 are shown below.

DBP: dibutyl phthalate

DNP: dinonyl phthalate

DOP: dioctyl phthalate

DIDP: di-i-decyl phthalate

PVP: polyvinyl pyrrolidone

H-1:tetrakis(vinylsulfonylmethyl)methane

H-2: 2,4-dichloro-6-hydroxy-s-triazine.sodium

HQ-1: 2,5-di-t-octyl hydroquinone

HQ-2: 2,5-di-sec-dodecyl hydroquinone

HQ-3: 2,5-di-sec-tetradecyl hydroquinone

HQ-4-2-sec-dodecyl-5-sec-tetradecyl hydroquinone

HQ-5: 2,5-di [(1,1-dimethyl-4-hexyloxybarbonyl) butyl] hydroquinone

Image stabilizing agent A: P-t-octyl phenol 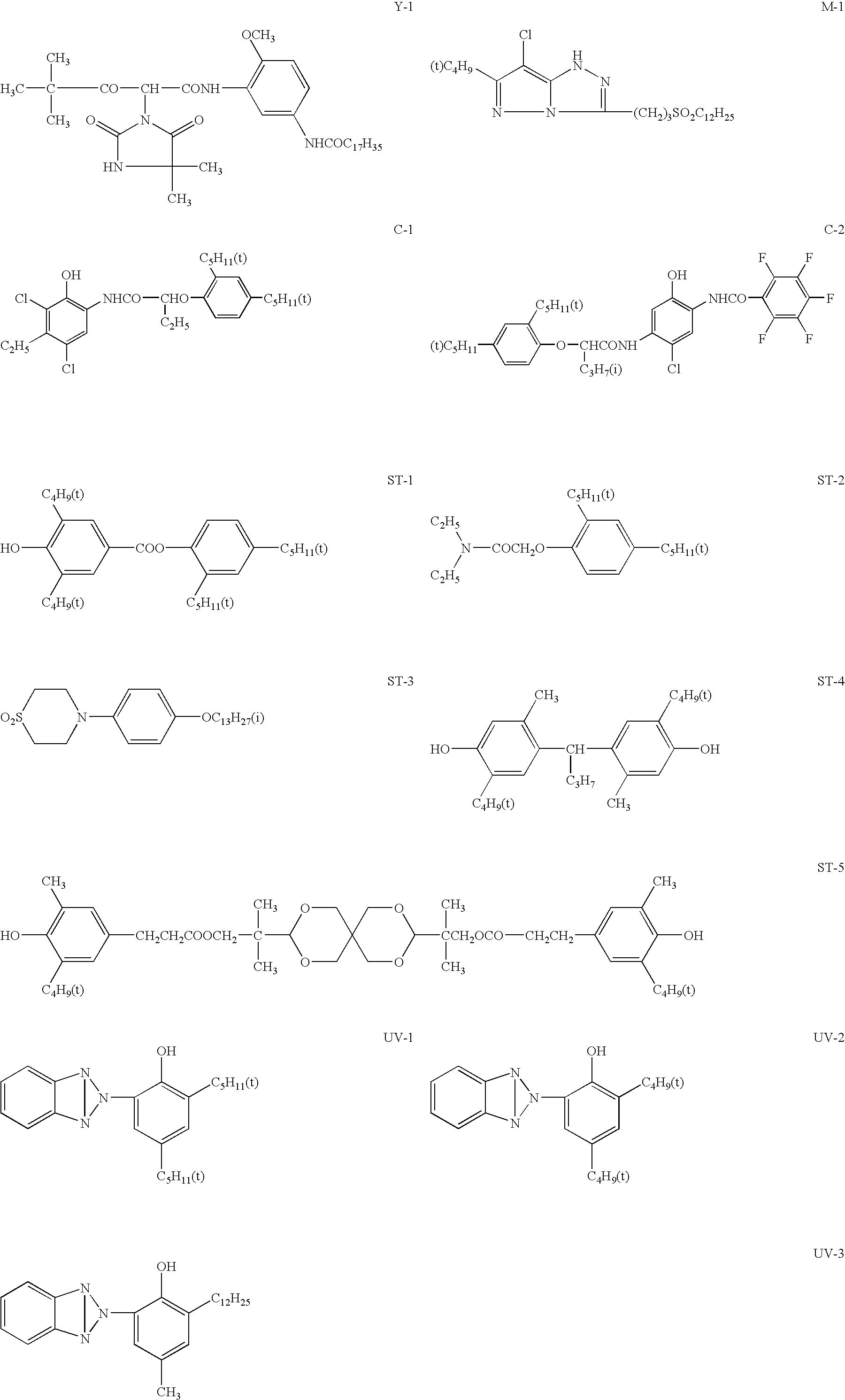 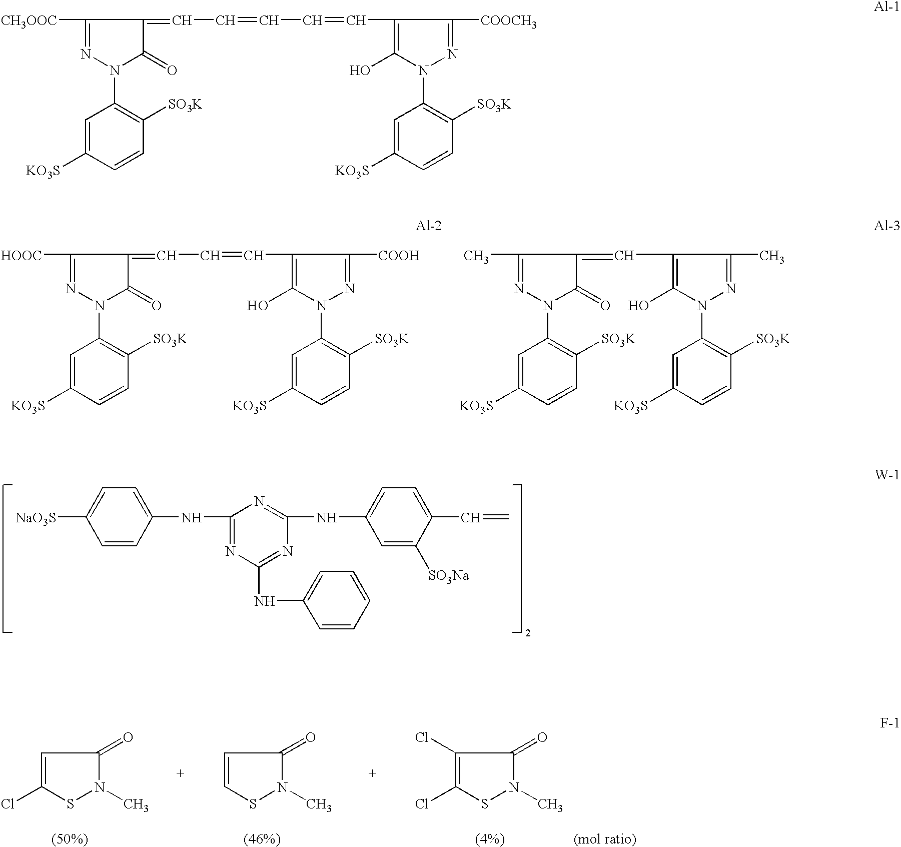
Preparation of Blue Sensitive Silver Halide Emulsion

To one liter of 2% aqueous solution of gelatin maintained at 40° C., simultaneously added were following Solution A and Solution B over 30 minutes while adjusting pAg to 7.3 and pH to 3.0, and further simultaneously added were following Solution C and Solution D over 180 minutes while adjusting pAg to 8.0 and pH to 5.5. The pAg adjustment was conducted based on the method described in JP-A 59-45437, while the pH adjustment was conducted using an aqueous solution of sulfuric acid or sodium hydroxide.

| Solution A | | |
|---|---|---|
| Sodium chloride | 3.42 | g |
| Potassium bromide | 0.03 | g |
| Water | to make total 200 ml | |
| Solution B | | |
| Silver nitrate | 10 | g |
| Water | to make total 200 ml | |
| Solution C | | |
| Sodium chloride | 102.7 | g |
| K₂IrCl₆ | 4 × 10⁻⁸ | mol/mol Ag |
| K₄Fe(CN)₆ | 2 × 10⁻⁵ | mol/mol Ag |
| Potassium bromide | 1.0 | g |
| Water | to make total 600 ml | |
| Solution D | | |
| Silver nitrate | 300 | g |

| | |
|---|---|
| Water | to make total 600 ml |

After the above addition, desalting was conducted using a 5% aqueous solution of Demol, produced by Kao Atlas Co., Ltd. and a 20% solution of magnesium sulfate, after which the gelatin solution was mixed to obtain monodispersed cubic emulsion EMP-1 featuring an average grain diameter of 0.71 μm, a variation coefficient of grain diameter distribution of 0.07, and a silver chloride content of 99.5 mol %. Subsequently, monodispersed cubic emulsion EMP-1B featuring an average grain diameter of 0.64 μm, a variation coefficient of grain diameter distribution of 0.07, and a silver chloride content of 99.5 mol %, was prepared in the same manner as EMP-1, except that addition time of Solutions A and B, and Solutions C and D, were changed.

Chemical sensitization was optimally conducted on above EMP-1 at 60° C. using the following compounds. Further, optimal chemical sensitization was similarly conducted on EMP-1B, after which sensitized EMP-1 and EMP-1B were mixed at the ratio of 1:1, to obtain Blue Sensitive Silver Halide Emulsion (Em-B).

| | | |
|---|---|---|
| Sodium thiosulfate | 0.8 | mg/mol AgX |
| Chloroauric acid | 0.5 | mg/mol AgX |
| Stabilizing agent: STAB-1 | 3 × 10⁻⁴ | mol/mol AgX |
| Stabilizing agent: STAB-2 | 3 × 10⁻⁴ | mol/mol AgX |
| Stabilizing agent: STAB-3 | 3 × 10⁻⁴ | mol/mol AgX |
| Spectral sensitizing dye: BS-1 | 4 × 10⁻⁴ | mol/mol AgX |
| Spectral sensitizing dye: BS-2 | 1 × 10⁻⁴ | mol/mol AgX |

Preparation of Green Sensitive Silver Halide Emulsion

Monodispersed cubic emulsion EMP-2 featuring an average grain diameter of 0.40 μm, a variation coefficient of grain diameter distribution of 0.08, and a silver chloride content of 99.5 mol %, was prepared in the same manner as EMP-1, except that addition time of Solutions A and B, and Solutions C and D, were changed. Subsequently, monodispersed cubic emulsion EMP-2B featuring an average grain diameter of 0.50 μm, a variation coefficient of grain diameter distribution of 0.08, and a silver chloride content of 99.5 mol %, was prepared.

Chemical sensitization was optimally conducted on above EMP-2 at 55° C. using the following compounds. Further, optimal chemical sensitization was similarly conducted on EMP-2B, after which sensitized EMP-2 and EMP-2B were mixed at the ratio of 1:1, to obtain Green Sensitive Silver Halide Emulsion (Em-G).

| | | |
|---|---|---|
| Sodium thiosulfate | 1.5 | mg/mol AgX |
| Chloroauric acid | 1.0 | mg/mol AgX |
| Stabilizing agent: STAB-1 | 3 × 10⁻⁴ | mol/mol AgX |
| Stabilizing agent: STAB-2 | 3 × 10⁻⁴ | mol/mol AgX |
| Stabilizing agent: STAB-3 | 3 × 10⁻⁴ | mol/mol AgX |
| Spectral sensitizing dye: GS-1 | 4 × 10⁻⁴ | mol/mol AgX |

Preparation of Red Sensitive-Silver Halide Emulsion

Monodispersed cubic emulsion EMP-3 featuring an average grain diameter of 0.40 μm, a variation coefficient of grain diameter distribution of 0.08, and a silver chloride content of 99.5 mol %, was prepared in the same manner as EMP-1, except that addition time of Solutions A and B, and Solutions C and D, were changed. Further, monodispersed cubic emulsion EMP-3B featuring an average grain diameter of 0.38 μm, a variation coefficient of grain diameter-distribution of 0.08, and a silver chloride content of 99.5 mol %, was prepared.

Chemical sensitization was optimally conducted on above EMP-3 at 60° C. using the following compounds. Further, optimal chemical sensitization was similarly conducted on EMP-3B, after which sensitized EMP-3 and EMP-3B were mixed at the ratio of 1:1, to obtain Red Sensitive Silver Halide Emulsion (Em-R).

| | | |
|---|---|---|
| Sodium thiosulfate | 1.8 | mg/mol AgX |
| Chloroauric acid | 2.0 | mg/mol AgX |
| Stabilizing agent: STAB-1 | 3 × 10⁻⁴ | mol/mol AgX |
| Stabilizing agent: STAB-2 | 3 × 10⁻⁴ | mol/mol AgX |
| Stabilizing agent: STAB-3 | 3 × 10⁻⁴ | mol/mol AgX |
| Spectral sensitizing dye: RS-1 | 1 × 10⁻⁴ | mol/mol AgX |
| Spectral sensitizing dye: RS-2 | 1 × 10⁻⁴ | mol/mol AgX |

STAB-1: 1-(3-acetamide phenyl)-5-mercaptotetrazole

STAB-2: 1-phenyl-5-mercaptotetrazole

STAB-3: 1-(4-ethoxyphenyl)-5-mercaptotetrazole

Further, to the red sensitive emulsion, added was SS-1 in an amount of 2.0×10⁻³ mol/mol AgX.

The details of additives employed in above spectral sensitive emulsion are shown below.

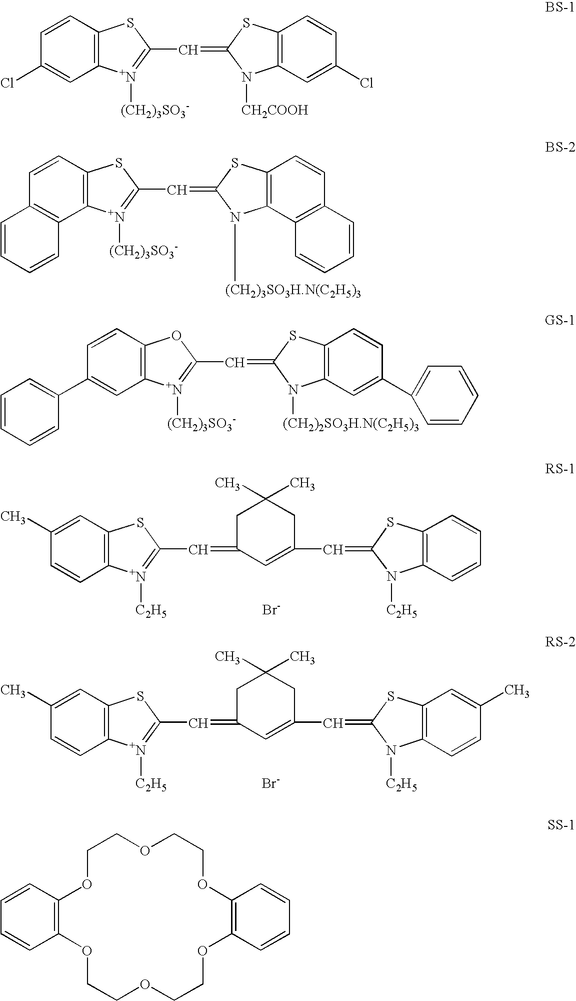

The sample prepared as above was designated as Sample 101.

Preparation of Samples 102 and 103

Samples 102 and 103 were prepared in a similar manner as Sample 101, except that the magenta coupler in the 3rd layer of Sample 103 was replaced by M-2, and ΔVE of Samples 102 and 103 were changed to 0.19 from 0.31 of Sample 101, adjusting the emulsion mixing ratio and coverage of each spectral sensitive layer. 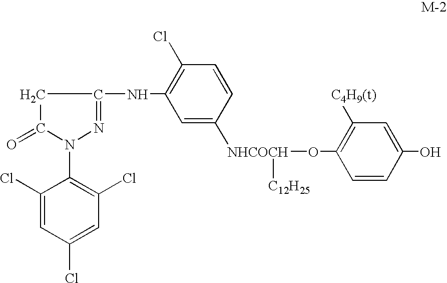
Evaluation of each Sample

Scanning exposure and photographic processing were conducted on the samples prepared as above. Scanning exposure was conducted using a laser diode (at an oscillation. wavelength of 650 nm), a He-Ne gas laser (at an oscillation wavelength of 544 nm), or an Ar gas laser (at an oscillation wavelength of 458 nm), modulating the amount of light with AOM to each laser beam based on image data, reflecting by a polygon mirror, for main scanning onto a photographic material, and at the same time, the photographic material was conveyed perpendicularly to the main scanning direction (being sub-scanning). The exposure number of seconds per pixel was set as 1×10⁻⁶ seconds. Simultaneously, the beam diameters of B, G and R were each confirmed to be 100 μm, using a beam monitor. Then, photographic processing was conducted employing the following processing steps, and a color print of a portrait image with text was prepared.

| Processing | Processing | | | Replenishing | |
|---|---|---|---|---|---|
| Step | Temperature | | Time | Rate | |
| Color | 38.0 ± 0.3° | C. | 45 sec. | 80 | ml/m² |
| development | | | | | |
| Bleach-fixing | 35.0 ± 0.5° | C. | 45 sec. | 120 | ml/m² |
| Stabilization | 30 − 34° | C. | 60 sec. | 150 | ml/m² |
| Drying | 60 − 80° | C. | 30 sec. | | |

The components of Color Developing Solution are listed below.

Color Developing Solution: Tank Solution and Replenishing Solution

| | Tank | | Replenishing | |
|---|---|---|---|---|
| | Solution | | Solution | |
| Water (deionized) | 800 | ml | 800 | ml |
| Triethylene diamine | 2 | g | 3 | g |
| Diethylene glycol | 10 | g | 10 | g |
| Potassium bromide | 0.01 | g | — | |
| Potassium chloride | 3.5 | g | — | |
| Potassium sulfite | 0.25 | g | 0.5 | g |
| N-ethyl-N-(β-methanesulfoneamidoethyl)- | 6.0 | g | 10.0 | g |
| 3-methyl-4-aminoaniline sulfuric salt | | | | |
| N,N-diethylhydroxylamine | 6.8 | g | 6.0 | g |
| Triethanolamine | 10.0 | g | 10.0 | g |
| Diethylenetriaminepentaacetic acid | 2.0 | g | 2.0 | g |
| penta-sodium salt | | | | |
| Fluorescent brightening agent (4,4′- | 2.0 | g | 2.5 | g |
| diaminostylbenedisulfonic acid derivative) | | | | |
| Potassium carbonate | 30 | g | 30 | g |

The total volume was brought to one liter by addition of water, and Tank Solution was adjusted to a pH of 10.10 while the Replenishing Solution was adjusted to a pH of 10.60.

Bleach-fixing Solution: Tank Solution and Replenishing Solution

| | | |
|---|---|---|
| Diethylenetriaminepentaacetate | 65 | g |
| ferric ammonium dihydrate | | |
| Diethylenetriaminepentaacetate | 3 | g |
| Ammonium thiosulfate | 100 | g |
| 2-amino-5-mercapto-1,3,4-thiadiazole | 2.0 | g |
| Ammonium thiosulfate (being a 40% solution) | 27.5 | ml |

The total volume was brought to 1 liter by addition of water, after which the pH was adjusted to 5.0 using potassium carbonate or glacial acetic acid.

Stabilizing Solution: Tank Solution and Replenishing Solution

| | | |
|---|---|---|
| o-phenylphenol | 1.0 | g |
| 5-chloro-2-methyl-4-isothiazoline-3-one | 0.02 | g |
| 2-methyl-4-isothiazoline-3-one | 0.02 | g |
| Diethylene glycol | 1.0 | g |
| Fluorescent brightening agent | 2.0 | g |
| (being Tinopal SFP) | | |
| 1-hydroxyethylidene-1,1′-disulfonic acid | 1.8 | g |
| Bismuth chloride (being a 45% solution) | 0.65 | g |
| Magnesium sulfate heptahydrate | 0.2 | g |
| PVP | 1.0 | g |
| Ammonia water (being a 25% solution of | 2.5 | g |
| ammonium hydroxide) | | |
| Trisodium nitriloacetate | 1.5 | g |

The total volume was brought to one liter by addition of water, after which the pH was adjusted to 7.5 using furic acid or ammonia water.

The bleeding degree of the text in images with text on each sample prepared as above was visually evaluated based on the criteria below:

A: No bleeding was observed.

B: Bleeding was observed.

Further, a single image was repeatedly printed 100 times, and density stability in the facial portion of prints was visually evaluated based on the following criteria.

A: Density fluctuation was negligible.

B: Density fluctuation was slight.

C: Density fluctuation was obvious.

The obtained results are shown below.

| | | | Color | Stability of | |
|---|---|---|---|---|---|
| Sample No. | Coupler | ΔVE | bleeding | facial image | Remarks |
| 101 | M-1 | 0.31 | B | C | Comp. |
| 102 | M-1 | 0.19 | A | B | Inv. |
| 103 | M-2 | 0.19 | A | A | Inv. |

Note:
Comp.: comparative sample
Inv.: this invention

### Example 2

Samples 201 and 202 were prepared in the same manner as Sample 101, except that Compound BB or Compound BC was employed as the additional metal complex to the iridium complex employed for preparation of the silver halide emulsion of each layer-in Example 1, and further ΔVE was adjusted as follows, and then the same evaluation as for Example 1 was conducted.

Compound BB: Os (NO) CL₅

Compound BC: [COCl₂ (2-methylimidazole)₂]

The obtained results are shown below.

| Sample | Additional | | Color | Facial image | |
|---|---|---|---|---|---|
| No. | Metal complex | ΔVE | bleeding | stability | Remarks |
| 101 | none | 0.31 | B | C | Comp. |
| 201 | Compound BB | 0.19 | A | B | Inv. |
| 202 | Compound BC | 0.19 | A | A | Inv. |

### INDUSTRIAL APPLICABILITY

As above, the silver halide photographic material of this invention provided images exhibiting less bleeding of text on the images. Further, when many prints were printed on photographic material -from a single image, facial image reproduction was staple. Further, as is apparent from Example 2, the silver halide photographic material of this invention exhibited the desired effects of this invention, in cases when the iridium metal complex was incorporated, and it was specifically proven that when a nitrosyl group containing complex or an imidazole group containing complex was employed, the desired effect of this invention was significant.

1. A silver halide color photographic material comprising a substrate, having thereon a yellow color image forming layer, a magenta color image forming layer and a cyan color image forming layer, all of which incorporate photosensitive silver halide grains,
wherein, when the silver halide color photographic material is exposed-with a laser light at an exposure time of 10⁻¹⁰ to 10⁻³ seconds per one pixel, and then is subjected to photographic processing to obtain a color image,
the difference of VE values (ΔVE) of the color image, between a maximum VE value and a minimum VE value, is between 0.0-0.2, in which VE is an effective gradation region of each color image forming layer in the obtained color image.

2. The silver halide color photographic material of claim 1, wherein at least one color image forming layer comprises a four equivalent coupler.

3. The silver halide color photographic material of claim 1, wherein at least one color image-forming layer comprises the silver halide grains containing a metal of the 8th to 10th groups in the periodic table.

4. The silver halide color photographic material of claim 2, wherein at least one color image forming layer comprises the silver halide grains containing a metal of the 8th to 10th groups in the periodic table.

5. The silver halide color photographic material of claim 3, wherein the metal of the 8th to 10th groups in the periodic table is contained in the silver halide grains as a metal complex having at least one ligand of nitrosyl or imidazole.

6. The silver halide color photographic material of claim 4, wherein the metal of the 8th to 10th groups in the periodic table is contained in the silver halide grains as a metal complex having at least one ligand of nitrosyl or imidazole.

7. An image forming method comprising the steps of:
a) exposing the silver halide color photographic material of claim 1, at an exposure time of 10⁻¹⁰ to 10⁻³ seconds per pixel, and
b) conducting color photographic processing on the exposed photographic material.

8. The image forming method comprising the steps of:
a) exposing the silver halide color photographic material of claim 2, at an exposure time of 10⁻¹⁰ to 10⁻³ seconds, and
b) conducting color photographic processing on the exposed photographic material.

9. The image forming method comprising the steps of:
a) exposing the silver halide color photographic material of claim 3, at an exposure time of 10⁻¹⁰ to 10⁻³ seconds, and
b) conducting color photographic processing on the exposed photographic material.

10. The image forming method comprising the steps of:
a) exposing the silver halide color photographic material of claim 4, at an exposure time of 10⁻¹⁰ to 10⁻³ seconds, and
b) conducting color photographic processing on the exposed photographic material.

11. The image forming method comprising the steps of:
a) exposing the silver halide color photographic material of claim 5, at an exposure time of 10⁻¹⁰-10⁻³ to seconds, and
b) conducting color photographic processing on the exposed photographic material.

12. The image forming method comprising the steps of:
a) exposing the silver halide color photographic material of claim 6, at an exposure time of 10⁻¹⁰ to 10⁻³ seconds, and
b) conducting color photographic processing on the exposed photographic material.
